(19) United States
(12) Patent Application Publication
(10) Pub. No.: US 2008/0000374 A1
(43) Pub. Date: Jan. 3, 2008

(54) Printing apparatus, patterning method, and method of fabricating liquid crystal display device using the same

(75) Inventors: Chul Ho Kim, Seoul (KR); Geun Tae Kim, Seoul (KR)

Correspondence Address: MORGAN LEWIS & BOCKIUS LLP, 1111 PENNSYLVANIA AVENUE NW, WASHINGTON, DC, 20004, US

(73) Assignee: L.G.Philips LCD Co., Ltd.

(21) Appl. No.: 11/812,599

(22) Filed: Jun. 20, 2007

(30) Foreign Application Priority Data
Jun. 21, 2006 (KR) P-2006-055861

(51) Int. Cl. B41F 35/00

(52) U.S. Cl. 101/425

(57) ABSTRACT

A printing apparatus includes a rail, a printing plate and a substrate on the rail, the printing plate and the substrate being movable along the rail, a printing roll to transcribe a pattern material onto the substrate after passing through the printing plate on the rail, and a cleaning device to clean the printing plate, the cleaning device including at least one of a chemical knife and an air knife.

The present invention claims the benefit of Korean Patent Application No. 2006-55861, filed in Korea on Jun. 21, 2006, which is hereby incorporated by reference.

### BACKGROUND OF THE INVENTION

1. Field of the Invention

The present invention relates to a liquid crystal display device, and more particularly, to a printing apparatus, patterning method, and method of fabricating a liquid crystal display device using the same.

2. Discussion of the Related Art

In general, a liquid crystal display (LCD) device can be widely used for notebook computers, monitors, spacecrafts, aircrafts, etc. since it has advantages such as low power consumption and portability. The LCD device includes lower and upper substrates facing each other, and a liquid crystal layer formed between the lower and upper substrates. Typically, the lower substrate includes a thin film transistor (TFT) and a pixel electrode, and the upper substrate includes a light-shielding layer, a color filter layer, and a common electrode.

The LCD device includes various elements formed by repeated manufacturing processes. A photolithography process is used so as to form the elements in various shapes. A method for patterning an element of the LCD using the photolithography process according to related art will be described with reference to the accompanying drawings.

FIGS. 1A to 1C are cross sectional views illustrating a related art method for patterning an element of the LCD using the photolithography process. First, as shown in FIG. 1A, a pattern material layer 20 is formed on a transparent substrate 10, and a photoresist layer 21 is formed on the pattern material layer 20. Then, as shown in FIG. 1B, a mask 25 having a predetermined pattern is positioned above the photo resist layer 21. In this state, a light-exposure apparatus (not shown) applies the light to the photo resist layer 21 through the mask 25. Thereafter, as shown in FIG. 1C, a development process is carried out, thereby forming photoresist patterns, and the pattern material layer 20 is etched using the photoresist patterns as a mask.

The photolithography process necessarily uses a mask, whereby the fabrication cost is increased. In addition, since the photolithography process requires exposure, development, and etching, the process is complex, and requires significant fabrication time.

To overcome these problems of the photolithography process, a new patterning method has been developed in which a printing method uses a printing roll and a printing plate. FIGS. 2A to 2D are cross sectional views illustrating a method of forming patterns on a substrate by a printing apparatus according to the related art.

As shown in FIG. 2A, a printing roll 30 having a blanket 32 adhered thereonto is prepared. Then, a material layer 20 is applied to the outer surface of the blanket 32 of the printing roll 30 through a printing nozzle 40, whereby the blanket 32 of the printing roll 30 is coated with the material layer 20.

Referring to FIG. 2B, the printing roll 30 having the blanket 32 adhered thereon is rolled on a printing plate 50 provided with a plurality of projections 55. Accordingly, some material layer 20b is transcribed on the projections 55 of the printing plate 50, and the other material layer 20a is left on the printing roll 30. That is, the other material layer 20a left on the printing roll 30 is patterned in a predetermined form. The blanket 32 adhered to the surface of the printing roll 30 is formed of a resin material having a predetermined elasticity so as to decrease friction between the printing roll 30 and the printing plate 50 when transcribing the pattern material 20a of the printing roll 30 on the printing plate 50. As shown in FIG. 2C, as the printing roll 30 having the patterned material layer 20a rolls on a substrate 10, the patterned material layer 20a is transcribed on the substrate 10.

The patterning method using the printing roll and the printing plate requires no mask having the predetermined pattern and requires no exposure, development, and etching. Thus, the patterning method decreases fabrication cost and time.

However, the patterning method using the printing roll according to the related art has the following disadvantage. After using the printing plate 50 once, the material layer 20b remains on the projections of the printing plate 50. Thus, it is necessary to carry out a cleaning step to reuse the printing plate 50.

### SUMMARY OF THE INVENTION

Accordingly, the present invention is directed to a printing apparatus, a patterning method, and a method of fabricating an LCD device using the same, which substantially obviates one or more problems due to limitations and disadvantages of the related art.

An object of the present invention is to provide a printing apparatus having a cleaning device for cleaning a printing plate to decrease the fabrication time and to realize a precise pattern.

Another object of the present invention is to provide a patterning method using the same.

Another object of the present invention is to provide a method of fabricating an LCD device using the same.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the printing apparatus, patterning method, and method of fabricating an LCD device using the same includes a printing apparatus including a rail, a printing plate and a substrate on the rail, the printing plate and the substrate being movable along the rail, a printing roll to transcribe a pattern material onto the substrate after passing through the printing plate on the rail, and a cleaning device to clean the printing plate, the cleaning device including at least one of a chemical knife and an air knife.

In another aspect, a patterning method includes the steps of coating a printing roll with a pattern material, transcribing some of the pattern material onto projections of a printing plate by rotating the printing roll on the printing plate, transcribing the remaining pattern material of the printing roll onto a substrate by rotating the printing roll on the substrate, cleaning the printing plate, and applying light to the printing plate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1A to 1C are cross sectional views illustrating a photolithography according to the related art;

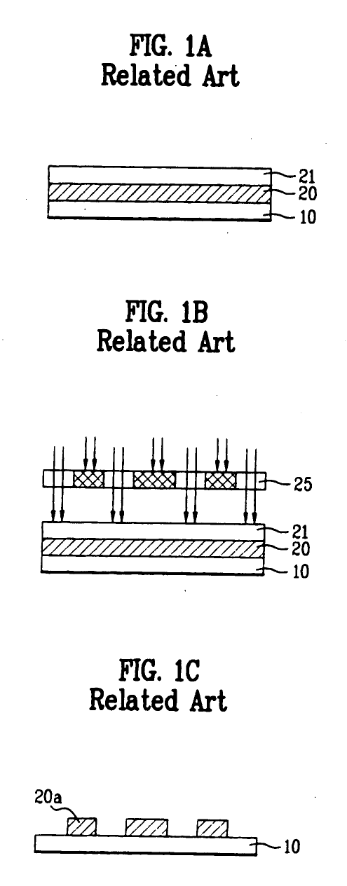

FIGS. 2A to 2C are cross sectional views illustrating a patterning method using a printing apparatus according to the related art;

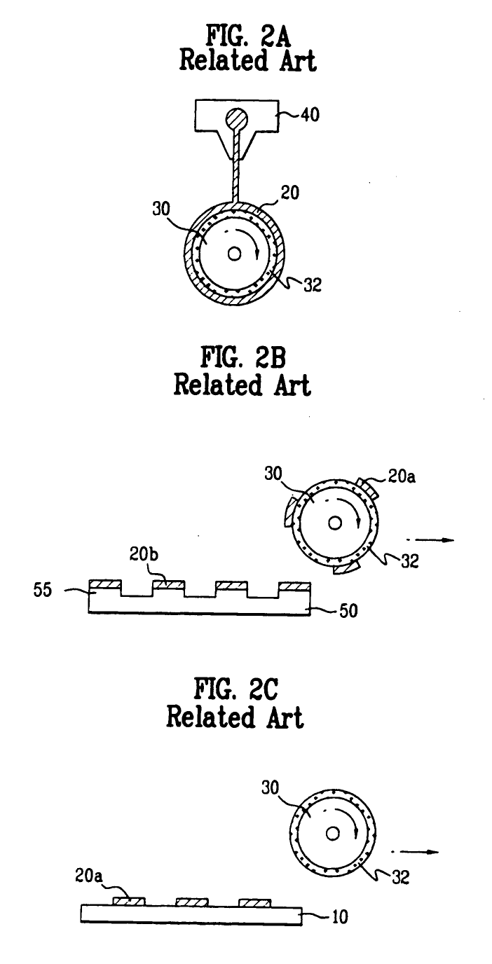

FIG. 3 is a perspective view illustrating an exemplary printing apparatus according to the first embodiment of the present invention;

FIG. 4 is a perspective view illustrating the inside of an exemplary cleaning device included in a printing apparatus according to the first embodiment of the present invention;

FIG. 5 is a cross sectional view along A-A′ of FIG. 4, which illustrates first and second slit nozzles included in the exemplary printing apparatus according to the first embodiment of the present invention;

FIG. 6 is a perspective view illustrating another exemplary printing apparatus according to the second embodiment of the present invention;

FIGS. 7A to 7F are cross section views illustrating an exemplary patterning method using a printing apparatus according to the preferred embodiment of the present invention; and

FIGS. 8A to 8D are cross section views illustrating an exemplary method of fabricating and LCD device according to the preferred embodiment of the present invention.

### DETAILED DESCRIPTION OF THE INVENTION

Reference will now be made in detail to the preferred embodiments of the present invention, examples of which are illustrated in the accompanying drawings. A printing apparatus, a patterning method using the same, and a method of fabricating an LCD device using the same will be explained with reference to the accompanying drawings.

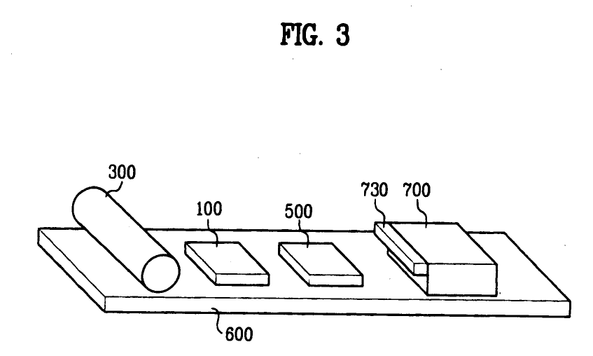

FIG. 3 is a perspective view illustrating an exemplary printing apparatus according to the first embodiment of the present invention. As shown in FIG. 3, the printing apparatus according to the first embodiment of the present invention is provided with a rail 600, a printing plate 500, a substrate 100, a printing roll 300, and a cleaning device 700. At this time, the printing plate 500 and the substrate 100 are positioned on, and are moved along the rail 600. The printing roll 300 transcribes a predetermined pattern on the substrate 100 through the printing plate 500 on the rail 600. Then, the cleaning device 700 cleans the printing plate 500, wherein the cleaning device 700 is positioned on the rail 600.

When providing the printing plate 500, the substrate 100, and the cleaning device 700 on the rail 600, they are arranged in the sequential order of the printing plate 500, the substrate 100, and the cleaning device 700.

The printing roll 300 coated with a pattern material (not shown) is moved to the printing plate 500 by horizontal and vertical movements, and is then moved to its original position, whereby some pattern material is transcribed on projections of the printing plate 500, the other pattern material is left on the printing roll 300. The other pattern material left on the printing roll 300 is transcribed on the substrate 100 in sequence. When the printing roll 300 is moved to the substrate 100 after transcribing the pattern material on the printing plate 500, the cleaning device 700 is moved to the printing plate 500 so as to clean the printing plate 500.

Although not shown, the above-mentioned elements may be arranged in the sequential order: printing plate 500, substrate 100, and cleaning device 700. In this sequential arrangement, when the printing roll 300 coated with the pattern material is moved to its original position after transcribing the pattern material on the printing plate 500 and the substrate 100, the cleaning device 700 is moved to the printing plate 500 so as to clean the printing plate 500.

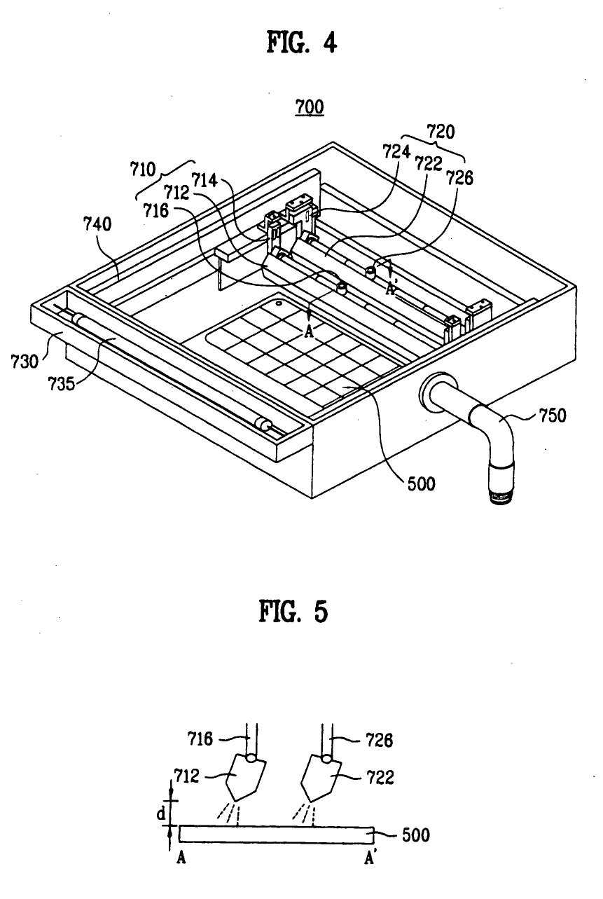

A structure and operation of the cleaning device. 700 will be explained in detail. FIG. 4 is a perspective view illustrating the inside of the cleaning device included in the printing apparatus according to the first embodiment of the present invention. As shown in FIG. 4, the cleaning device 700 includes a chemical knife 710, an air knife 720, a light irradiator 730, a guide rail 740, and an organic-material discharger 750.

The chemical knife 710 includes a first slit nozzle 712, a first driver 714 for driving the first slit nozzle 712, and a cleaning-solution supplier 716 to supply a cleaning solution to the first slit nozzle 712. The first slit nozzle 712 formed in the shape of a bar sprays the cleaning solution supplied from the cleaning-solution supplier 716 onto the printing plate 500 under a high-pressure state. The first slit nozzle 712 is spaced apart from the printing plate 500 by an interval of about 1˜2 mm. The first driver 714 is formed at each of both sides of the first slit nozzle 712. The first driver 714 moves the first slit nozzle 712 to clean the printing plate 500.

The air knife 720 includes a second slit nozzle 722, a second driver 724 for driving the second slit nozzle 722, and an air supplier 726 to supply air to the second slit nozzle 722. The second slit nozzle 722 formed in shape of a bar sprays the air supplied from the air supplier 726 onto the printing plate 500 under a high-pressure state. The second slit nozzle 722 is spaced apart from the printing plate 500 by an interval of about 1˜2 mm. The second driver 724 is formed at each of both sides of the second slit nozzle 722. The second slit nozzle 722 is maintained at a predetermined interval from the first slit nozzle 712, the second driver 724 moves the second slit nozzle 722 to dry the printing plate 500 on which the cleaning solution is sprayed.

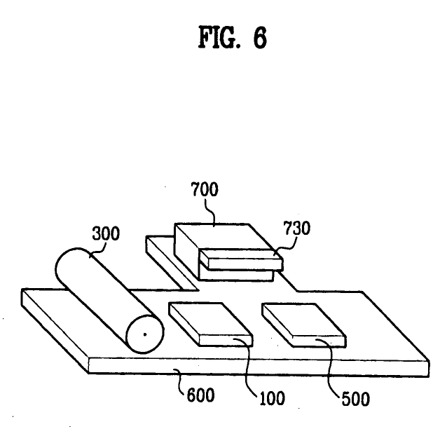

FIG. 5 is a cross sectional view along A-A′ of FIG. 4, which illustrates the first and second slit nozzles 712 and 722 included in the printing apparatus according to the first embodiment of the present invention. As shown in FIG. 5, the first and second slit nozzles 712 and 722 are spaced apart from the printing plate 500 by an interval (d) of about 1˜2 mm. The first and second slit nozzles 712 and 722 are inclined with respect to a vertical plane of the printing plate 500 by a predetermined angle.

The first and second slit nozzles 712 and 722 spray cleaning solution and air onto the printing plate 500. Since the first and second slit nozzles 712 and 722 are inclined toward the proceeding direction of the printing plate 500, it helps remove the pattern material from the printing plate 500 after cleaning the printing plate 500, thereby improving the cleaning efficiency.

The light irradiator 730 is formed at the outer side of the cleaning device 700. The light irradiator 730 includes a light source 735 formed therein. When the cleaning device 700 is moved to its original position after cleaning the printing plate 500 by the chemical knife 710 and/or the air knife 720, the light irradiator 730 moves downward along the side of the cleaning device 700, and applies the light to the printing plate 500. Preferably, the light source 735 of the light irradiator 730 emits UV rays.

After being cleaned by the cleaning solution and dried by air, the printing plate 500 reacts with the oxygen of the air, and an oxide layer may be formed on the surface of the printing plate 500. As the UV rays are applied to the printing plate 500, the oxide layer of the printing plate 500 is removed.

The guide rail 740 is formed at both sides of the first and second slit nozzles 712 and 722, whereby the guide rail 740 is connected to the first and second drivers 714 and 724 to drive the first and second slit nozzles 712 and 722. Thus, the guide rail 740 helps the first and second slits nozzles 712 and 722 to move at a predetermined interval of about 1˜2 mm from the printing plate 500.

The cleaning solution sprayed by the first slit nozzle 712 and the pattern material separated from the printing plate 500 are discharged through the organic-material discharger 750 to the outside of the cleaning device 700. There is an additional fan (not shown) to discharge the cleaning solution and the pattern material to the outside of the cleaning device 700.

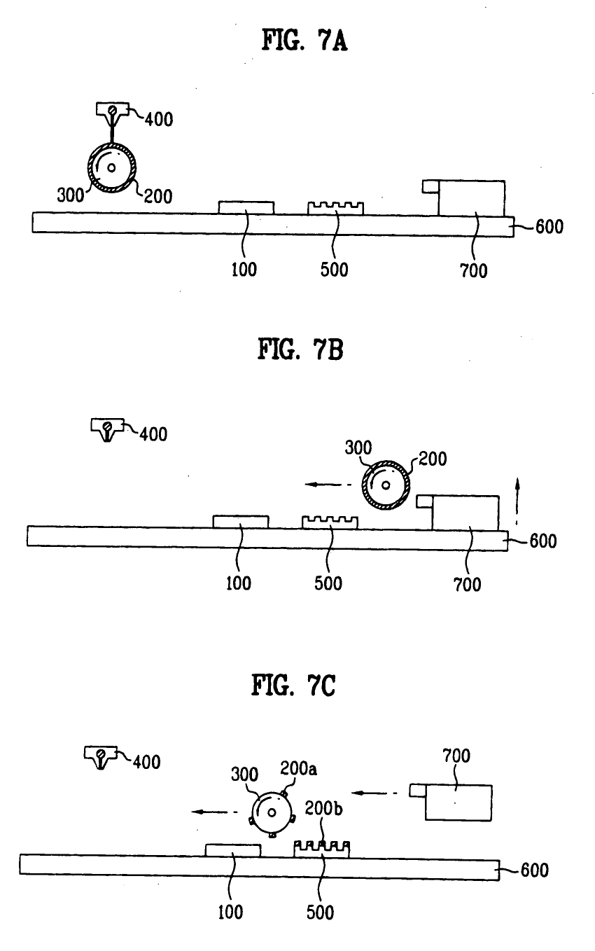

FIG. 6 is a perspective view illustrating another exemplary printing apparatus according to the second embodiment of the present invention. Except for the arrangement of the cleaning device 700, other components included in the exemplary printing apparatus according to the second embodiment of the present invention are similar to those included in the exemplary printing apparatus according to the first embodiment of the present invention, as shown in FIG. 6.

As shown in FIG. 6, the cleaning device 700 is arranged in perpendicular to the straight line provided by the substrate 100 and the printing plate 500, that is, the proceeding direction of the printing roll 300. When the cleaning device 700 returns to its original position after cleaning the printing plate 500, the light irradiator 730 of the cleaning device 700 emits the light to the printing plate 500. -Accordingly, it is preferable to provide the light irradiator 730 at the side of the cleaning device 700 that opposes the printing plate 500. Although not shown, the organic-material discharger 750 may be formed at the side of the cleaning device 700 that opposes the light irradiator 730. An operation method of the printing apparatus according to the second embodiment of the present invention is similar to the operation method of the printing apparatus according to the first embodiment of the present invention.

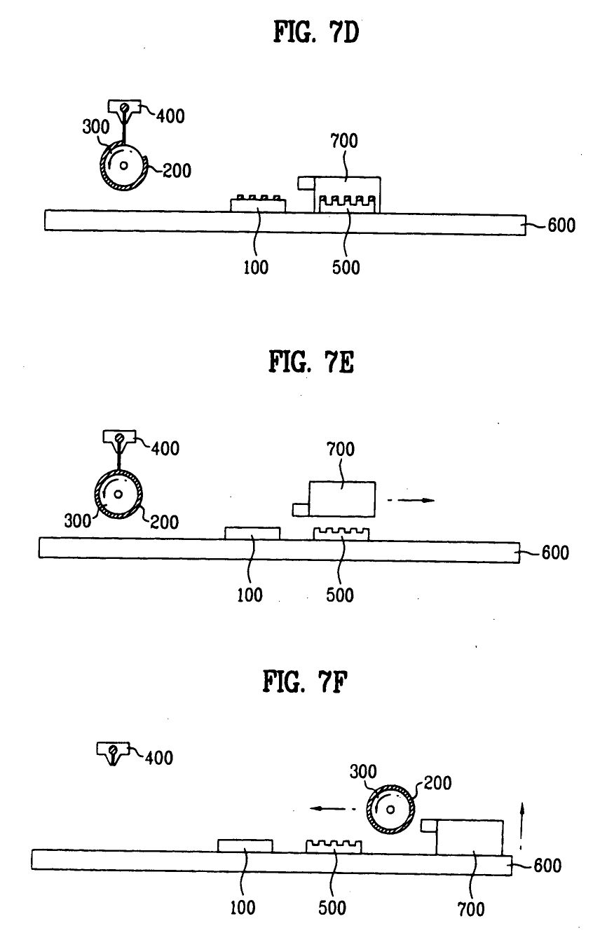

FIGS. 7A to 7F are cross sectional views illustrating an exemplary patterning method using the printing apparatus according to the preferred embodiment of the present invention. As shown in FIG. 7A, the pattern material 200 is provided through a printing nozzle 400, and is coated on the printing roll 300. Then, as shown in FIG. 7B, the printing roll 300 rolls on the printing plate 500, the printing plate 500 including a plurality of projections. Accordingly, as shown in FIG. 7C, some pattern material 200b is transcribed on the projections of the printing plate 500, and the other pattern material 200a is left on the printing roll 300. That is, the other pattern material 200a left on the printing roll 300 is formed in a predetermined form by the printing plate 500. At this time, the cleaning device 700 moves in the upward direction. Then, the printing roll 300 rolls on the substrate 100, whereby the pattern material 200a left on the printing roll 300 is transcribed on the substrate 100. At this time, the cleaning device 700 moves toward the printing plate 500 in the horizontal direction.

As shown in FIG. 7D, the printing roll 300 moves to the printing nozzle 400, and then the pattern material 200 is reapplied to the surface of the printing roll 300. Then, the cleaning device 700 cleans and dries the printing plate 500. At this time, the light irradiator 730 formed at the side of the cleaning device 700 moves downward to apply the light to the printing plate 500.

As shown in FIG. 7E, after cleaning and drying the printing plate 500, the cleaning device 700 moves in an upward direction, and then the cleaning device 700 is restored to its original position. At this time, the light irradiator 730 formed at the side of the cleaning device 700 applies light to the printing plate 500 through its movement in an horizontal direction. Accordingly, it is possible to remove the oxide layer formed on the surface of the printing plate 500.

The substrate 100 having the pattern thereon is replaced with the new substrate I 00. Afterwards, the printing roll 300 coated with the pattern material 200 is moved to the cleaned printing plate 500, and then the pattern material 200 is transcribed on the printing plate 500. Then, the steps of FIGS. 7C to 7E are repeatedly carried out.

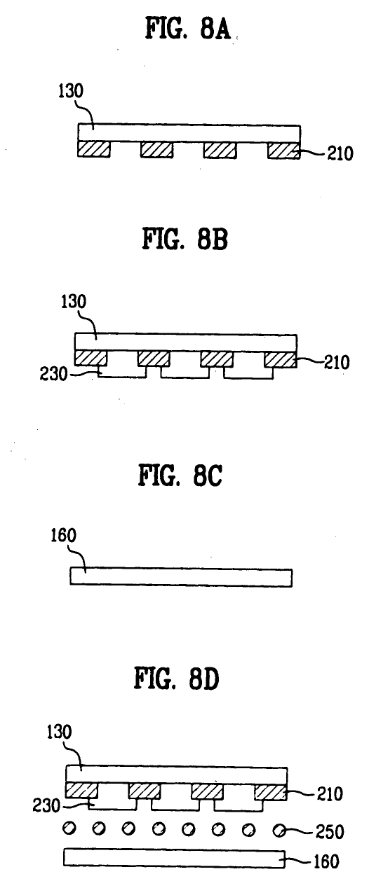

FIGS. 8A to 8D are cross sectional views illustrating an exemplary method of fabricating an LCD device according to the preferred embodiment of the present invention. First, as shown in FIG. 8A, a light-shielding layer 210 is formed on a first substrate 130. Then, as shown in FIG. 8B, a color filter layer 230 is formed on the first substrate 130 including the light-shielding layer 210. At least any one of the light shielding layer 210 and the color filter layer 230 is formed by the above-mentioned patterning method. A common electrode (not shown) is formed on the color filter layer 230.

As shown in FIG. 8C, a second substrate 160 is prepared. The step of preparing the second substrate 160 uses the above-mentioned patterning method. The second substrate includes gate and data lines (not shown) crossing each other to define a pixel region (not shown), a thin film transistor (not shown) formed adjacent to a crossing portion of the gate and data lines, and a pixel electrode (not shown) connected to the thin film transistor.

As shown in FIG. 8D, a liquid crystal layer 250 is formed between the first and second substrates 130 and 160. At this time, the liquid crystal layer 250 may be formed by a dispensing method or an injection method. If applying the dispensing method of liquid crystal, a sealant (not shown) having no inlet is formed in any one of the first and second substrates 130 and 160, and liquid crystal is dispensed on any one of the first and second substrates 130 and 160, and then the two substrates are bonded to each other. If applying the injection method, after bonding the two substrates with a sealant (not shown) having an inlet, liquid crystal is injected into a space between the two substrates by capillary phenomenon and pressure difference.

As mentioned above, the printing apparatus, patterning method and method of fabricating the LCD device according to the present invention have the following advantages. First, the use of an expensive mask is unnecessary. Accordingly, the patterning method of the present invention does not require the exposure and development. Thus, fabrication cost and time are decreased.

Second, since the printing system according to the present invention includes a cleaning device to clean the printing plate. Accordingly, the process using the printing system according to the present invention is simplified since there is no additional cleaning process.

Third, when the cleaning device comes back to its original position after cleaning the printing plate, the oxide layer formed in the surface of the printing plate is removed by the light irradiator formed at the side of the cleaning device. Thus, the oxide layer is removed without consuming the additional period of time.

It will be apparent to those skilled in the art that various modifications and variations can be made in the printing apparatus, patterning method, and method of fabricating an LCD device using the same of the present invention without departing from the spirit or scope of the invention. Thus, it is intended that the present invention cover the modifications and variations of this invention provided they come within the scope of the appended claims and their equivalents.

What is claimed is:

1. A printing apparatus, comprising:
a rail;
a printing plate and a substrate on the rail, the printing plate and the substrate being movable along the rail;
a printing roll to transcribe a pattern material onto the substrate after passing through the printing plate on the rail; and
a cleaning device to clean the printing plate, the cleaning device including at least one of a chemical knife and an air knife.

2. The printing apparatus according to claim 1, wherein the cleaning device further includes a bar-shaped light irradiator.

3. The printing apparatus according to claim 2, wherein the light irradiator includes a UV-rays irradiator.

4. The printing apparatus according to claim 2, wherein the light irradiator is disposed at an outer side of the cleaning device.

5. The printing apparatus according to claim 4, wherein the light irradiator moves in upward and downward directions.

6. The printing apparatus according to claim 1, wherein the cleaning device includes an organic-material discharger.

7. The printing apparatus according to claim 6, wherein the organic-material discharger includes a fan.

8. The printing apparatus according to claim 1, wherein the chemical knife includes a first slit nozzle to spray a cleaning solution, a first driver to drive the first slit nozzle, and a cleaning-solution supplier to supply the cleaning solution to the first slit nozzle.

9. The printing apparatus according to claim 8, wherein the air knife includes a second slit nozzle to spray air, a second driver to drive the second slit nozzle, and an air supplier to supply the air to the second slit nozzle.

10. The printing apparatus according to claim 9, wherein the first or second slit nozzle is maintained at an interval of about I to 2mm from the upper surface of the printing plate when cleaning the printing plate.

11. The printing apparatus according to claim 9, wherein the first or second slit nozzle is inclined with respect to a vertical plane of the printing plate by a predetermined angle.

12. The printing apparatus according to claim 1, wherein both the chemical knife and the air knife are driven at the same time.

13. A patterning method, comprising the steps of:
coating a printing roll with a pattern material;
transcribing some of the pattern material onto projections of a printing plate by rotating the printing roll on the printing plate;
transcribing the remaining pattern material of the printing roll onto a substrate by rotating the printing roll on the substrate;
cleaning the printing plate; and
applying light to the printing plate.

14. The patterning method according to claim 13, wherein the step of cleaning the printing plate comprises the steps of:
moving a cleaning device to the printing plate;
spraying a cleaning solution onto the printing plate; and
drying the printing plate by spraying air on the printing plate.

15. The patterning method according to claim 13, wherein the step of applying light to the printing plate applies UV rays to the printing plate.

16. The patterning method according to claim 13, wherein the step of cleaning the printing plate is carried out after transcribing some of the pattern material on the projections.

17. The patterning method according to claim 13, wherein the step of applying light to the printing plate is carried out after the step of cleaning the printing plate.

18. A method of fabricating an LCD device, comprising the steps of:
forming a light-shielding layer on a first substrate;
forming a color filter layer on the first substrate including the light-shielding layer;
preparing a second substrate; and
forming a liquid crystal layer between the first and second substrates,
wherein at least one of the forming a light-shielding layer on a first substrate and the forming a color filter layer on the first substrate uses the printing apparatus of claim 1.

19. The method according to claim 18, wherein the step preparing a second substrate comprises the steps of:
forming gate and data lines crossing each other to define a pixel region on the second substrate by the printing apparatus of claim 1;
forming a thin film transistor adjacent to the crossing portion of the gate and data lines;
forming a passivation layer on the second substrate; and
forming a pixel electrode connected to the drain electrode of the thin film transistor on the passivation layer.
